(19) United States
(12) Patent Application Publication
(10) Pub. No.: US 2017/0177762 A1
(43) Pub. Date: Jun. 22, 2017

(54) DATA CENTER THREE DIMENSION TEMPERATURE AND HUMIDITY CONTOUR GENERATOR AND METHOD

(71) Applicant: Archimedes Controls Corp., Pleasanton, CA (US)

(72) Inventors: Xiang LIU, San Francisco, CA (US); Liangcai TAN, Dublin, CA (US); Xin HU, Dublin, CA (US)

(73) Assignee: Archimedes Controls Corp., Pleasanton, CA (US)

(21) Appl. No.: 15/382,058

(22) Filed: Dec. 16, 2016

Related U.S. Application Data
(60) Provisional application No. 62/269,917, filed on Dec. 18, 2015.

(51) Int. Cl. G06F 17/50; G06T 17/00

(52) U.S. Cl. CPC G06F 17/5009; G06T 17/00

(57) ABSTRACT

Disclosed is an internet browser based data center 3D dynamic temperature and humidity contour generator. The generator will collect real time rack temperature and humidity sensor data, convert the measured data to be 3D temperature and humidity data through inverse weight coefficient interception, then display these data along the rack's surface in internet browsers to inform data center operator.

### CROSS-REFERENCE TO RELATED APPLICATION

This application claims the benefit of U.S. Provisional Application No. 62/269,917, filed Dec. 18, 2015, the entire contents of which are incorporated herein by reference.

### FIELD OF THE INVENTION

The present invention relates to vividly disclosing thermal conditions of data centers, in particular to generation and display of three-dimension temperature and humidity contours of computer racks in data centers.

### BACKGROUND OF THE INVENTION

A cool thermal environment is critical to data center's safe operation. Data center thermal environment is dynamic due to constant changing envelope load and computer load/heat. It's also uneven because of chaotic heat flow and cool air flow. Perception and understanding of the complex thermal condition by operational staffs and cooling systems of data centers are very important to proper control of the cooling systems in maintaining the cool and adequate thermal environment. To capture such complicated thermal condition, large amount of thermal sensors are needed based on the current practice but budget and space constraints limit the amount of thermal sensors that can be installed, and therefore compromise the level of details and accuracy of the captured thermal environment. In addition, there is a lack of intuitive, vivid and convenient means of demonstrating such rich information and data to the operation staffs. Some solutions were proposed. But they are plagued by one or more of the limitations mentioned above, such as limited thermal sensors, coarse thermal data analysis method, clumsy presentation of captured information or others. None of them provide a complete and effective solution.

It would be advantageous to provide an algorithm that infers the complex thermal environment in data centers based on limited temperature and humidity sensors.

It would also be advantageous to provide a method to display the three dimensional thermal contour in platform independent internet browsers.

It would further be advantageous to provide a method to display vast amount of thermal data in a fast manner.

### SUMMARY OF THE INVENTION

In accordance with the present invention, there is provided an internet browser based 3-D dynamic temperature and humidity contour generator for data centers. The generator uses an advanced mathematic method to reconstruct data center 3D temperature and humidity field from limited real time rack temperature and humidity sensor data, pick the data at the racks' surfaces and display them in a 3D temperature and humidity contour format in internet browsers. In spite of large amount of data exchange in a very short time period, the method allows fast display and refreshment of the 3D model in the browser, easy orbitation of the 3D model and full observation from any angle, which facilitate interaction between the model and data center operator and the operator's understanding of the thermal condition of the data centers.

In some embodiments, a data center three dimension temperature and humidity contour generator for generate temperature and humidity contour data of data center racks and display the three-dimension contour in internet browsers includes one or more programs including instructions for: building a 3D model of the racks and the data center using a programming language that is able to show 3D temperature and humidity contour data in internet browsers independent of platforms; using an advanced mathematic method to reconstruct the entire 3D thermal field based on measured data from limited thermal sensors at a moment; retrieving 3D thermal contour data for rack surfaces and displaying it in internet browsers using the 3D model; creating a scene to provide background for temperature and humidity contour display, subsequently connected to said means for build a 3D model of the racks and the data center using a programming language that's able to show 3D temperature and humidity contour data in internet browsers independent of platforms; creating camera and perspective to provide observation object and angle; creating orbit control so that the 3D model and field can be rotated and seen from any angle; and creating rack object and surfaces, and dividing each surface into tens of millions of sub-surfaces, subsequently connected to said means for use an advanced mathematic method to reconstruct the entire 3D thermal field based on measured data from limited thermal sensors at a moment.

In some embodiments, a system for generating and displaying three dimension temperature and humidity contours for data center racks comprises a memory, one or more processors, one or more programs, wherein the one or more programs are stored in the memory and configured to execute by the one or more processors, the one or more programs including instructions for: creating a 3D model of racks of a data center, producing a 3D thermal field data based on data from a specific time for a plurality of thermal sensors, using the 3D thermal field data to produce contour data for rack surfaces, and graphically display the 3D thermal filed data in an internet browsers using the 3D model.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a plan view of a flow process of the 3D thermal contour generation and display method;

FIG. 2 is a plan view of a flow process of data center 3D temperature and humidity contour display model generation method;

FIG. 3 is a plan view of a 3D model scene;

FIG. 4 is a perspective view of a 3D data center model from different rotation angle;

FIG. 5 is a detail view of a rack with small sub-surfaces; and

FIG. 6 is a plan view of a data center full temperature and humidity color rendering.

For purposes of clarity and brevity, like elements and components will bear the same designations and numbering throughout the Figures.

### DETAILED DESCRIPTION OF THE INVENTION

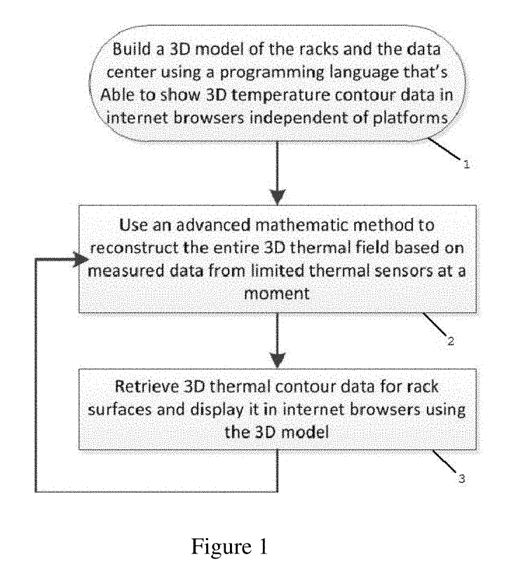

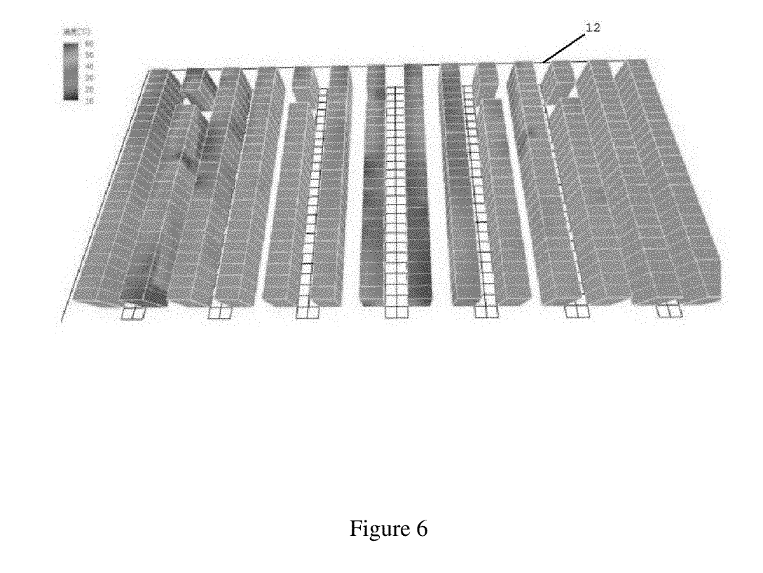

FIG. 1 is a plan view of a flow process of the 3D thermal contour generation and display method. At box overall start 1, a 3D model of a data center and its computer racks is built using an internet compliant programming language, for example Java Script. Any internet browser is able to display the model, independent of operation systems. At box interpolate 2, an advanced mathematic method, for example, inverse distance weighted (IDW) interpolation method, to reconstruct the entire temperature and humidity field based on measured temperature and humidity data from limited temperature and humidity sensors. In general, the advanced mathematic method should be one that results in smoother and more accurate temperature and humidity field by having minor lineaments and less display of maxima. At box retrieve and display 3, temperature and humidity data at desired locations, in this case rack surfaces, is retrieved, fed into the 3D model built at box overall start 1, and displayed in internet browsers in a very fast manner at a predefined interval. The view rendering 12 in FIG. 6 illustrates a snapshot of the data center 3D temperature and humidity contour model. At next time interval, the process restarts at box interpolate 2 and cycles.

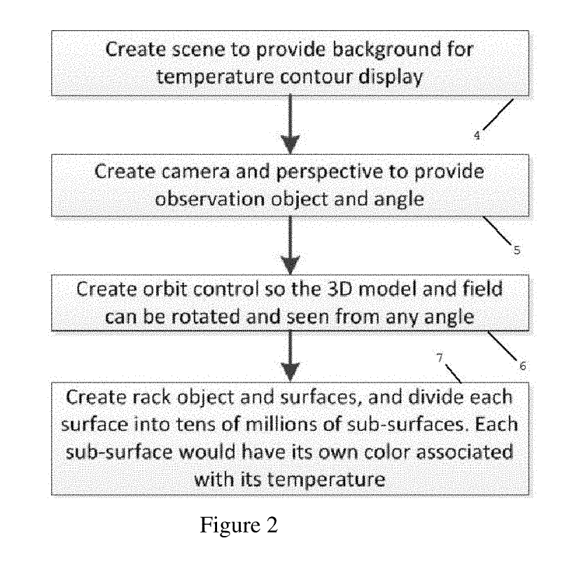

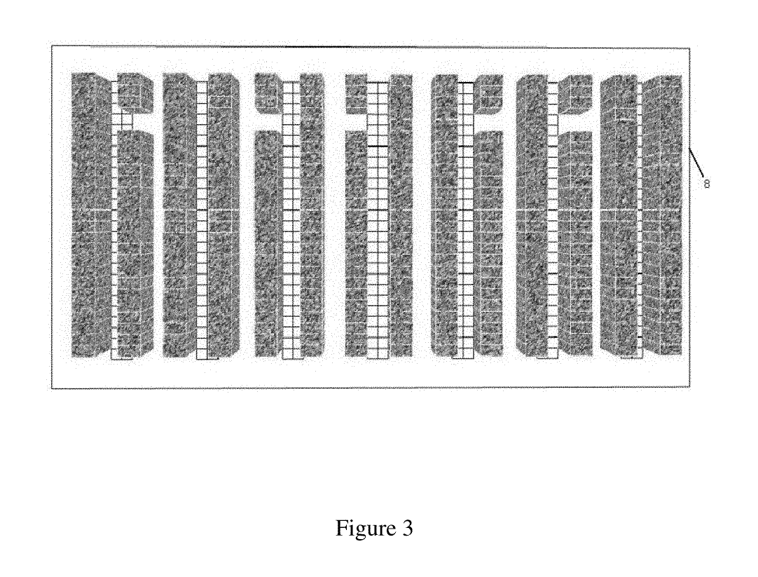

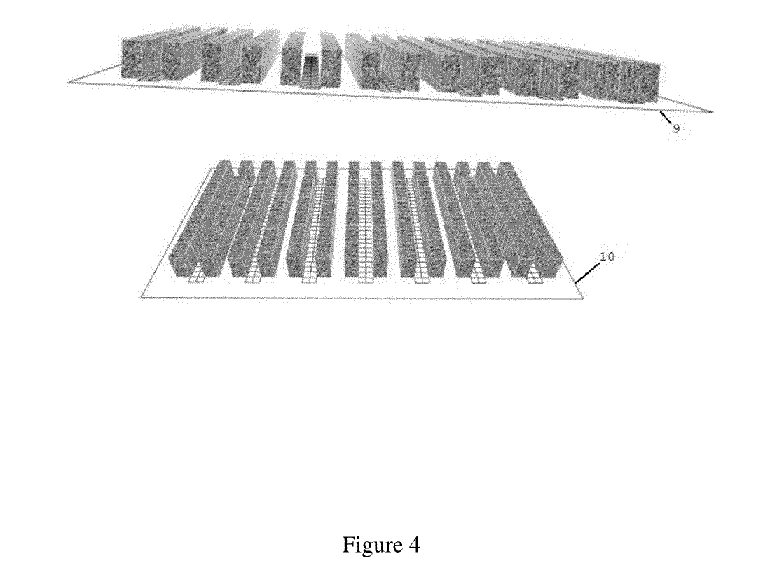

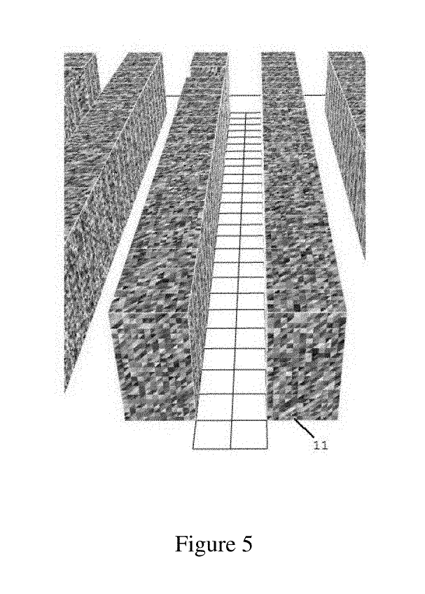

FIG. 2 is a plan view of a flow process of data center 3D temperature and humidity contour display model generation method. It's a detailed breakdown for the box overall start 1 in FIG. 1. At box scene 4, a scene is created as background for the temperature and humidity contour display, as shown in view scene 8 in FIG. 3. At box camera 5, a camera is then created acting as an observation object and allowing specifying an observation angle. At box orbit 6, an orbit control is built as a means to rotate the 3D model and field, allowing a user to see the model from any angle. Two orbit views, view rotation 19 and view rotation 20 in FIG. 4 illustrate how a model looks like from different perspective using the orbit control. At the last step, box rack objects 7, rack objects and surfaces are created. Each surface is divided into tens of millions of sub-surfaces, and each sub-surface would have its own color determined by its temperature and humidity using a predefined color vs. temperature and humidity correlation, as shown in view subsurface 11 in FIG. 5.

In some embodiments, the method can be implemented using one or more computer systems. The system can be a microprocessor-based device, such as a personal computer, workstation, server, handheld computing device such as a phone or tablet, or distributed computing system (e.g., cloud computing system). The system can include, for example, one or more processors, communication devices, input devices, output devices, storage, and/or software stored on storage and executable by the processors. The components of the computer can be connected in any suitable manner, such as via one or more physical buses or wirelessly.

In some embodiments, the system may include server-side computing components as well as client-side computing components. In some embodiments, some or all components may be part of a distributed computing system (e.g., a cloud computing system). In some embodiments of the techniques disclosed herein, for example, storage may be storage provisioned by a cloud computing system, such that a user may send instructions to the cloud computing system over one or more network connections, and the cloud computing system may execute the instructions in order to leverage the cloud computing components in accordance with the instructions. In some embodiments, cloud computing systems may be configured to be capable of executing the same or similar program code in the same programming languages as other systems (e.g., servers, personal computers, laptops, etc.) as discussed herein.

The processors may be any suitable type of computer processor capable of communicating with the other components of system in order to execute computer-readable instructions and to cause the system to carry out actions in accordance with the instructions. For example, the processors may access a computer program (e.g., software) that may be stored on storage and execute the program to cause the system to perform various actions in accordance with the program. In some embodiments, a computer program or other instructions executed by the processors may be stored on any transitory or non-transitory computer-readable storage medium readable by the processors.

A communication device may include any suitable device capable of transmitting and receiving signals over a network, such as a network interface chip or card. System may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

An input device may be any suitable device that provides input, such as a touch screen or monitor, keyboard, mouse, button or key or other actuatable input mechanism, microphone and/or voice-recognition device, gyroscope, camera, or IR sensor. An output device may be any suitable device that provides output, such as a touch screen, monitor, printer, disk drive, light, speaker, or haptic output device.

Storage can be any suitable device the provides storage, such as an electrical, magnetic or optical memory including a RAM, cache, hard drive, CD-ROM drive, tape drive or removable storage disk.

Software, which may be stored in storage and executed by the processors, may include, for example, the programming that embodies the functionality of the methods, techniques, and other aspects of the present disclosure (e.g., as embodied in the computers, servers and devices as described above). In some embodiments, software may include a combination of servers such as application servers and database servers.

Software can also be stored and/or transported within any computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium that can contain or store programming for use by or in connection with an instruction execution system, apparatus, or device.

Software can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

The system can implement any one or more operating systems suitable for operating on the network. Software 112 can be written in any one or more suitable programming languages, such as C, C++, Java or Python. In various embodiments, application software embodying the functionality of the present disclosure can be deployed in different configurations, such as in a client/server arrangement or through a Web browser as a Web-based application or Web service, for example.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated by reference.

What is claimed is:

1. A system for generating and displaying three dimension temperature and humidity contours for data center racks comprising:
memory;
one or more processors;
one or more programs, wherein the one or more programs are stored in the memory and configured to execute by the one or more processors, the one or more programs including instructions for:
creating a 3D model of racks of a data center;
producing a 3D thermal field data based on data from a specific time for a plurality of thermal sensors;
using the 3D thermal field data to produce contour data for rack surfaces; and
graphically display the 3D thermal filed data in an internet browsers using the 3D model.
